(19) United States
(12) Patent Application Publication
(10) Pub. No.: US 2025/0135869 A1
(43) Pub. Date: May 1, 2025

(54) VEHICLE WITH COUPLED COOLING CIRCUITS FOR COOLING AN ELECTROCHEMICAL CELL

(71) Applicant: MAN Truck & Bus SE, München (DE)

(72) Inventors: Stefan BUHL, MÜNCHEN (DE); Alexander Schydlo, MÜNCHEN (DE)

(21) Appl. No.: 18/682,864

(22) PCT Filed: Aug. 1, 2022
(86) PCT No.: PCT/EP2022/071575

§ 371 Date: Feb. 9, 2024

(30) Foreign Application Priority Data
Aug. 10, 2021 (DE) 10 2021 120 744.4

(51) Int. Cl. B60K 11/04; H01M 8/04007; H01M 8/04029; H01M 8/04701

(52) U.S. Cl. CPC B60K 11/04; H01M 8/04029; H01M 8/04074; H01M 8/04701; H01M 2250/20

(57) ABSTRACT

The invention relates to a vehicle (10), comprising an electrochemical cell (1) and a first coolant circuit (2.1) for cooling said electrochemical cell (1). Furthermore, the vehicle (10) has a second coolant circuit (2.2), fluidically separated from the first coolant circuit (2.1), which is thermally coupled to the first coolant circuit (2.1) via an exchange heat exchanger (W_{A}). The first coolant circuit (2.1) comprises a first heat exchanger (W₁) for heat exchange with the vehicle surroundings, and the second coolant circuit (2.2) comprises a second heat exchanger (W₂) for heat exchange with the vehicle surroundings, wherein the first heat exchanger (W₁), seen in the forward direction of travel (V) of the vehicle (10), is arranged in front of the second heat exchanger (W₂). The invention furthermore relates to a method for operating such a vehicle (10).

The invention relates to a vehicle having an electrochemical cell and two coolant circuits, wherein the two coolant circuits are thermally coupled via a heat exchanger. The invention also relates to a method for operating such a vehicle.

Cooling of a fuel cell of a motor vehicle is in principle known in the prior art. The cooling is normally carried out by means of appropriate coolant or refrigerant circuits, via which heat from the fuel cell is dissipated to the vehicle surroundings with the aid of a circulating coolant or refrigerant. For a heat exchange between the respective media, use is typically made of heat exchangers, such as ribbed tube or fin heat exchangers.

In order to ensure the performance and service life of the fuel cells, in particular under high-load or full-load conditions, the highest possible cooling output of the cooling device is desirable with, at the same time, an energy demand that is as low as possible. Accordingly, it is an object of the invention to provide such cooling of a vehicle fuel cell, wherein disadvantages of previous solutions are to be avoided.

This object can be achieved with the features of the independent claim 1. Advantageous embodiments and applications of the invention are the subject matter of the dependent claims and are explained in more detail in the following description with partial reference to the figures.

According to a first independent solution idea, a vehicle is provided. Preferably, the vehicle is a motor vehicle, particularly preferably a utility vehicle (e.g. a truck). For example, the vehicle can be an electric vehicle (e.g. a fuel cell vehicle), i.e. a vehicle which can be driven with electrical energy (e.g. by means of an electric motor).

The vehicle comprises an electrochemical cell (e.g. a fuel cell) and a coolant circuit for cooling this electrochemical cell. The aforementioned coolant circuit is also to be designated below as a “first” or “primary” coolant circuit in order to distinguish it better.

Furthermore, the vehicle comprises a further “second” or “secondary” coolant circuit fluidically separated from the first coolant circuit. The expression “fluidically separated” can here indicate that there is no direct fluid connection between the first and second coolant circuit permitting a coolant exchange between the two coolant circuits. Nevertheless, the first coolant circuit and the second coolant circuit are thermally coupled to each other via a heat exchanger designated as an “exchange heat exchanger”. Expressed in another way, an exchange of heat can be carried out between the two coolant circuits (i.e. between the first coolant circuit and the second coolant circuit) but no material exchange.

Provision is further made for the first coolant circuit to comprise a heat exchanger (e.g. a heat exchanger and/or radiator) for the preferably direct heat exchange with the vehicle surroundings. Here, this heat exchanger (e.g. an air/coolant heat exchanger) is to be designated below as a “first heat exchanger”. The electrochemical cell can be connected, preferably directly, to this first heat exchanger by means of the first coolant circuit.

In addition, the second coolant circuit also comprises a heat exchanger (e.g. a heat exchanger and/or radiator) for the preferably direct heat exchange with the vehicle surroundings, which is to be designated below as a “second heat exchanger”. The second heat exchanger is preferably also an air/coolant heat exchanger.

Now, in order to advantageously ensure the highest possible temperature difference between the respective heat exchangers and the vehicle surroundings, and therefore to achieve the highest possible cooling performance, the first heat exchanger—seen in the forward direction of travel of the vehicle—is arranged in front of the second heat exchanger. Here, the direction in which the vehicle moves during normal forward travel (without any steering angle) can be understood as the “forward direction of travel”. For example, the first heat exchanger can be arranged on or in a front vehicle region (e.g. in the region of the “front-end” of the vehicle), and the second heat exchanger on or in a rear vehicle region (e.g. in the region of the vehicle rear). Particularly preferably, the statements “front” and “rear” relate to the position of the electrochemical cell. This means, in other words, that the first heat exchanger (seen in the forward direction of travel) can be arranged in front of the electrochemical cell, and the second heat exchanger (seen in the forward direction of travel) can be arranged behind the electrochemical cell. Preferably, the first and second heat exchangers are thus not arranged beside and/or not adjacent to one another. As a result of the above-described “division” or “modularization” of the otherwise normally usually simple or individual fuel cell coolant circuit into two coupled coolant circuits (first/second coolant circuit), expedient operation of the cooling can therefore advantageously be achieved overall—as will be explained in more detail below—with, in addition, a more specific arrangement of temperature levels in the vehicle being made possible. For example, as a result, at least one of the following advantages can thus be realized: for example, the air preheating can be taken into account when arranging the heat exchangers, and therefore a relevant temperature difference can be ensured for all the heat exchangers; for all the components to be cooled, the most equal temperature level for the cooling can be provided, which can primarily be determined by the first heat exchanger; a modular approach can be provided, in which cooling surfaces can expediently be added or removed; and expedient control of the heat dissipation from the respective heat exchangers, depending on the output requirement, can be made possible.

According to a first aspect of the invention, the vehicle can comprise a driver's cab. According to conventional understanding, this can be understood to mean a cabin for accommodating a vehicle driver, that is to say the part of the structure of a utility vehicle that forms the space for the vehicle driver and possibly accompanying persons. Here, the second heat exchanger—seen in the forward direction of travel—can be arranged behind the driver's cab. Additionally or alternatively, the second heat exchanger can be arranged on an outer rear wall of the driver's cab. Additionally or alternatively, the second heat exchanger can be arranged on or in the “tower” of the utility vehicle. Advantageously, as a result, a flow around the second heat exchanger of air pre-heated by other vehicle components can be avoided as far as possible and, in addition, a dissipation of heat that influences the further vehicle components as little as possible can be achieved.

According to a further aspect of the invention, the first heat exchanger can be arranged next to a vehicle front of the vehicle. Here, the vehicle front can be understood to be that region of the vehicle which is located at the very front with respect to the normal forward direction of travel, which can also be designated as the “front end”. Additionally or alternatively, the first heat exchanger can be arranged next to and/or adjacent to a radiator grille of the vehicle, preferably flush with the vehicle front. Additionally or alternatively, the first heat exchanger can also be arranged next to and/or adjacent to a front apron, front fender and/or front paneling of the vehicle. Additionally or alternatively, the first heat exchanger can also be arranged in the region of the vehicle front and/or (seen in the forward direction of travel) in front of the front axle. As a result, during travel, an adequate flow around the first heat exchanger with a flow of air not pre-heated by other vehicle components can advantageously be achieved.

According to a further aspect of the invention, the first heat exchanger, seen in the forward direction of travel, can be arranged, preferably completely, in front of the electrochemical cell.

For example, the rear side of the first heat exchanger (seen in the forward direction of travel) can be arranged in front of the front side of the electrochemical cell. Additionally or alternatively, for example, the center of gravity of the first heat exchanger (seen in the forward direction of travel) can also be located in front of the center of gravity of the electrochemical cell.

According to a further aspect of the invention, the second heat exchanger, seen in the forward direction of travel, can be arranged, preferably completely, behind the electrochemical cell. For example, the front side of the second heat exchanger (seen in the forward direction of travel) can be arranged behind the rear side of the electrochemical cell. Additionally or alternatively, for example, the center of gravity of the second heat exchanger (seen in the forward direction of travel) can also be arranged behind the center of gravity of the electrochemical cell.

According to a further aspect of the invention, the electrochemical cell, seen in the forward direction of travel, can be arranged between the first heat exchanger and the second heat exchanger. Expressed in another way, the first heat exchanger can be arranged in front of the electrochemical cell, and the second heat exchanger can be arranged behind the electrochemical cell. Thus, advantageously, modularization of the cooling with the most economical fluid guidance possible to the respective heat exchangers can be achieved overall.

According to a further aspect of the invention, the second heat exchanger can be arranged higher with respect to the vehicle vertical direction than the first heat exchanger. Here, the “vehicle vertical direction” can be understood as the spatial direction perpendicular to the base plate of the vehicle and oriented along the direction of gravity. This means that the second heat exchanger (seen in the vehicle vertical direction) can be arranged, preferably completely, above the first heat exchanger. Particularly preferably, an upper side of the first heat exchanger (seen in the vehicle vertical direction) is arranged underneath an underside of the second heat exchanger. Advantageously, as a result, a flow toward the second heat exchanger of air possibly preheated by the first heat exchanger can be avoided as far as possible during travel, and therefore an adequate temperature difference on all the heat exchangers can be ensured.

According to a further aspect of the invention, the exchange heat exchanger can be arranged with respect to a coolant flow within the first coolant circuit, upstream of the first heat exchanger and downstream of the electrochemical cell. The expression “upstream” is to be understood—in accordance with the conventional understanding—as “placed counter to the coolant flow”, and the expression “downstream” as “placed in the direction of the coolant flow”. In other words, the corresponding components are arranged such that the coolant flows firstly through the electrochemical cell, then the exchange heat exchanger and lastly the first heat exchanger. As a result, effective pre-cooling of the coolant emerging at the electrochemical cell, in particular in high-load or full-load operation at high temperature, before it reaches the first heat exchanger connected downstream, can advantageously be achieved.

According to a further aspect of the invention, the second coolant circuit can be used preferably exclusively for pre-cooling the first coolant circuit. Preferably, the exclusive purpose of the second coolant circuit is thus the appropriate pre-cooling of the first coolant circuit. Additionally or alternatively, no further components to be cooled and/or to be heated (such as a motor, a traction battery, an interior heater, etc.) can be incorporated in the second coolant circuit. Expressed in another way, the second coolant circuit can be used exclusively for heat exchange between the vehicle surroundings and the first coolant circuit. Additionally or alternatively, the second coolant circuit can be thermally coupled to the electrochemical cell, preferably exclusively, via the exchange heat exchanger and the first coolant circuit. For example, here there may be no direct coupling of the second coolant circuit to the electrochemical cell.

According to a further aspect of the invention, the first coolant circuit can be designed to dissipate heat from the electrochemical cell to the second coolant circuit by means of the exchange heat exchanger in a first phase of the cooling and to dissipate it to the vehicle surroundings by means of the first heat exchanger in a second phase of the cooling, preferably following the first phase. In other words, the first coolant circuit can be designed for two-stage heat dissipation. For example, in the event that the electrochemical cell is highly loaded (for example in high-load or full-load operation), initially, in the first phase of the cooling, the dissipation of heat—enabled by the exchange heat exchanger and the second coolant circuit—can be carried out on the tower (e.g. behind the driver's cab), and then, in the second phase of the cooling, the dissipation of heat can be carried out in the front end of the vehicle with the aid of cooling air flowing through there. Expressed in other words, the second heat exchanger, which can be considered here to be a secondary heatsink, of the second coolant circuit can be thermally connected to the surroundings in series before the first heat exchanger, which can be viewed here as a primary heatsink, of the first coolant circuit. As a result, the heat output to be dissipated at the first heat exchanger can advantageously be reduced, as a result of which components possibly arranged behind the first heat exchanger have less warm air flowing around them and, as a result, are heated up less. The temperature difference at the respective heat exchangers in the case of the second heat exchanger (enabled by the exchange heat exchanger) may be due to the relatively high temperature of the coolant following its emergence from the electrochemical cell and the possibly heated surrounding temperature behind the driver's cab, while, in the case of the first heat exchanger, it may be due to the pre-cooled coolant following its emergence from the exchange heat exchanger and the relatively cold surrounding temperature in the front area. Overall, the total efficiency, the power output and the service life of the system can therefore advantageously be increased.

According to a further aspect of the invention, the first heat exchanger can be an air/coolant heat exchanger (e.g. a fin heat exchanger). An “air/coolant heat exchanger” can be understood as a heat exchanger which enables an exchange of heat between the media consisting of (surrounding) air and coolant (e.g. water). In other words, the first heat exchanger can be designed to permit a heat exchange between the coolant of the first coolant circuit (e.g. water) and the surrounding air of the vehicle. The first heat exchanger here can also comprise a fan (e.g. in the form of a radiator fan). Additionally or alternatively, the second heat exchanger can also be an air/coolant heat exchanger. This means that the second heat exchanger can be designed to permit an exchange of heat between the coolant of the second coolant circuit (e.g. water) and the surrounding air of the vehicle. The second heat exchanger can optionally also comprise a fan (e.g. in the form of a radiator fan). Additionally or alternatively, the exchange heat exchanger can be an coolant/coolant heat exchanger (e.g. a plate heat exchanger). Preferably, the exchange heat exchanger is designed for an exchange of heat between two liquid coolants.

According to a further aspect of the invention, the vehicle can comprise control equipment (e.g. a control device). The control equipment can be designed to operate the first coolant circuit and/or the second coolant circuit. The “operating” can preferably comprise control and/or regulation. For example, the control equipment can be designed to operate or to control and/or to regulate the respective coolant pumps and/or fans of the two coolant circuits.

According to a further aspect of the invention, the control equipment can be designed to operate the first coolant circuit independently of the second coolant circuit. For example, the control equipment can be designed to operate the respective coolant pumps of the two coolant circuits independently of each other. As a result, the cooling output produced by the corresponding coolant circuits can advantageously be expediently controlled or regulated to the greatest extent possible. Merely by way of example, for example in the case in which the surrounding air behind the driver's cab is not warmed up extremely and the thermal potential for the effective transfer of heat to the surroundings is sufficient, only the first coolant circuit is thus used as a heat sink. The second coolant circuit, which is thermally connected to the first coolant circuit via the exchange heat exchanger, can then be conceived as an additional heatsink for high and full load.

According to a further aspect of the invention, the control equipment can also be designed to operate only the first coolant circuit for cooling the electrochemical cell in a first operating mode (e.g. a low-load operation) and/or to operate the first coolant circuit and the second coolant circuit in a second operating mode (e.g. a high-load or full-load operation). In this connection, it is also possible to speak of a first cooling stage (first operating mode) and a second cooling stage (second operating mode). Furthermore, even if in the present case M₂ the second coolant circuit is operated together with the first coolant circuit, the first and second coolant circuit can in principle be operable independently of each other. This means that it may in principle be possible, for example in one operating mode, to operate only the second coolant circuit. Here, the expression “operating” can in each case generally be understood to be a flow or circulation of coolant in the first or second coolant circuit and/or connecting up the corresponding fans of the heat exchangers. For example, the “operating” can be carried out by driving appropriate coolant pumps in the first or second coolant circuit. As a result, overall expedient and energy-efficient control of the cooling output can advantageously be made possible, depending on the current output power requirement. For example, the first coolant circuit can be dimensioned averagely with respect to cooling output and energy consumption so that it permits adequate cooling under usual operating conditions. In the event of mostly short-term output peaks, the second coolant circuit can then be connected up as an additional heatsink, as a result of which the two coolant circuits can overall advantageously be dimensioned smaller with regard to their effectiveness and therefore as a rule also with regard to their weight and energy consumption. Preferably, however, it is also possible to realize other functional arrangements or sequences of the cooling.

According to a further aspect of the invention, the control equipment can also be designed to determine an operating mode of the first and/or second coolant circuit that is optimized with regard to a predefined target function. Preferably, the predefined, i.e. previously stipulated, target function can be a target function relating to energy minimization. Alternatively, however, it can also be other target functions, for example a target function relating to operating cost minimization or a target function relating to maximizing the heat transfer. As a “target function”—in accordance with the conventional understanding in the area of optimization—a function formed on the basis of a mathematical model incorporating model parameters and restrictions of the system can be understood, which is then subjected to a mathematical optimization, such as an extreme value formation. For example, in the present case, merely by way of example, the following variables can be taken into account in connection with the target function: the necessary cooling output, the design and/or energy consumption of the components of the coolant circuits (e.g. pumps, fans), ambient temperatures at the location of the heat exchangers, coolant temperature, etc. Furthermore, the control equipment can be designed to operate the first and/or second coolant circuit in accordance with the determined optimized operating mode. As a result, overall the most efficient and low-energy operation of the cooling of the electrochemical cell can advantageously be achieved.

According to a further aspect of the invention, the second coolant circuit can be a refrigerant circuit. In other words, instead of a coolant, a refrigerant (e.g. R134a) can circulate in the second “coolant circuit”. The refrigerant circuit—according to the conventional structure—can also have a compressor and a throttling device. Advantageously, the pre-cooling of the first coolant circuit can thus be increased once more.

Previously, the first and second coolant circuit were primarily described with regard to their components important to the invention. However, it can immediately be seen by those skilled in the art that the first or second coolant circuit can additionally also comprise further components—usual in this connection. Thus, the first coolant circuit can, for example, also have a first coolant pump for coolant delivery and/or an expansion tank and/or additional radiators or heat exchangers. Additionally or alternatively, the second coolant circuit can also comprise, for example, a “second” coolant pump for coolant delivery and/or an expansion tank and/or additional radiators or heat exchangers.

Moreover, the above-described device was primarily described in the context of cooling an electrochemical cell. Here, too, however, it can immediately be seen by those skilled in the art that the cooling according to the invention can likewise be used for cooling other types of low-temperature energy converters and/or electronic components. In other words, the “electrochemical cell” can generally also be a “low-temperature energy converter” and/or an electronic component.

According to a further independent solution idea, a method for operating a vehicle, as described in this document, is also provided. The vehicle described in connection with the method can thus have all the features as have already been described in this document in terms of the vehicle itself and vice versa. This means that the features of the vehicle disclosed in relation to the device are intended also to be disclosed and claimable in connection with the method. Here, the method comprises the steps: determining an operating mode optimized with regard to a predefined target function of the first and/or second coolant circuit. Preferably, the predefined, i.e. previously stipulated, target function is a target function relating to energy minimization. Thus, the most energy-saving operation of the vehicle or of the cooling of the electrochemical cell can advantageously be realized. Alternatively, however, the target function can also be, for example, a target function relating to operating cost minimization or a target function relating to maximizing the heat transfer. In connection with the optimization and the target function, for example the following variables can be taken into account: necessary cooling output (e.g. high-load operations, full-load operation or partial load operation), energy consumption of the components of the coolant circuits (such as pumps, fans), output limits of the corresponding components, ambient temperatures at the location of the heat exchangers (first or second heat exchanger) and/or coolant temperature in the first or second coolant circuit. To determine the optimized operating mode, known algorithms relating to optimization (e.g. evolutionary algorithms) or heuristic methods can be used. Furthermore, the method comprises the step of operating the first and/or second coolant circuit in accordance with the determined optimized operating mode. For example, the optimized operating mode may merely provide for the operation of the first coolant circuit (e.g. in the event of a low cooling output requirement) or, for example, an operation of both coolant circuits (e.g. in the case of a high-load or full-load operation). As a result, overall an operation of the cooling of the electrochemical cell that is as optimal as possible with regard to predefined criteria can advantageously be made possible.

The previously described aspects and features of the invention can be combined with one another as desired. Further details and advantages of the invention are described below with reference to the appended drawings, in which:

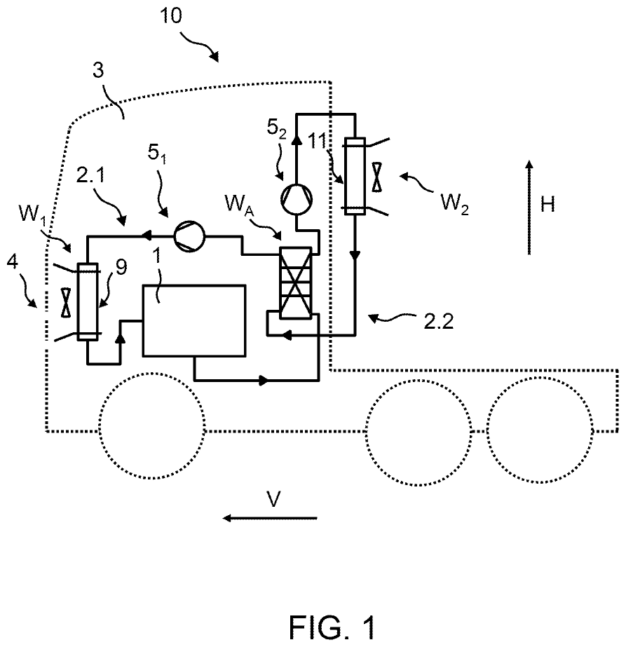

FIG. 1: shows a schematic illustration of a vehicle according to a first embodiment of the invention;

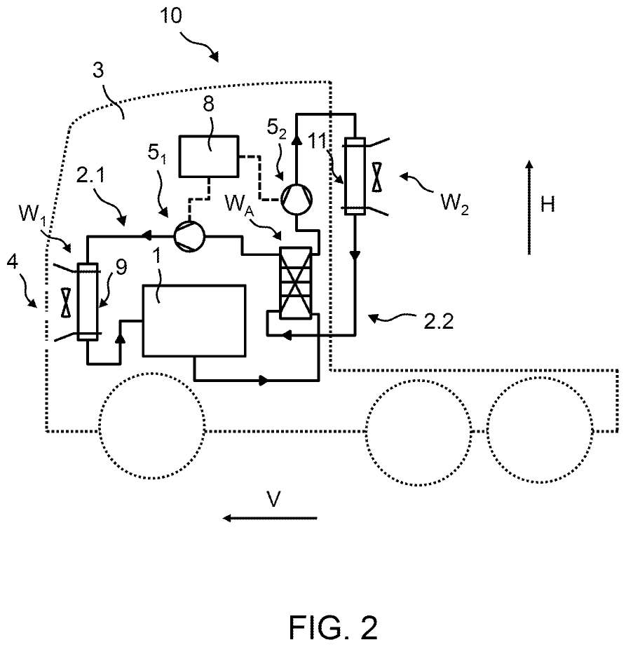

FIG. 2: shows a schematic illustration of a vehicle according to a second embodiment of the invention, and

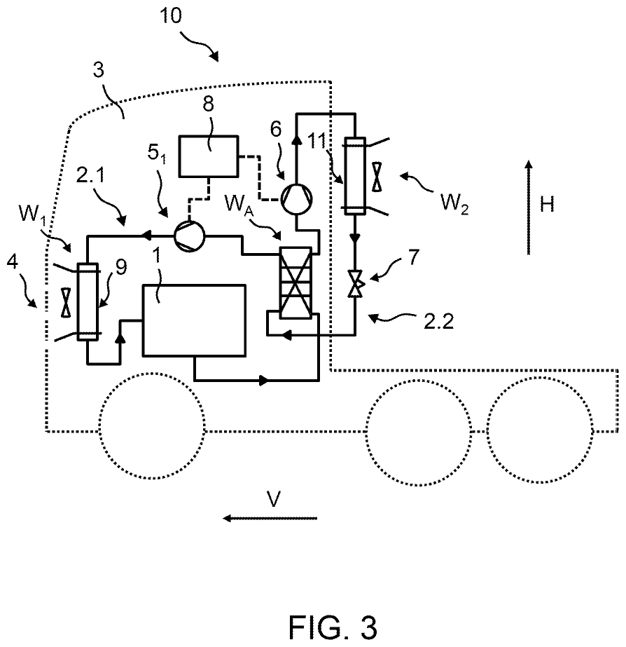

FIG. 3: shows a schematic illustration of a vehicle according to a third embodiment of the invention.

The same or functionally equivalent elements are described with the same designations in all the figures and to some extent are not described separately.

FIG. 1 shows a schematic illustration of a vehicle 10 according to a first embodiment of the invention. In the present case, the vehicle 10—merely by way of example—is a tractor-trailer unit having a driver's cab 3. The vehicle 10 comprises an electrochemical cell 1, preferably a fuel cell, and a first coolant circuit 2.1 for cooling the electrochemical cell 1. According to the usual understanding, the expression “coolant circuit” can generally be understood to mean a device for transporting heat by means of a coolant carried in a closed line system. The first coolant circuit 2.1 has a first heat exchanger W₁ for an exchange of heat with the vehicle surroundings. The first coolant circuit 2.1 can also comprise a coolant pump 5₁, which is to be designated as a “first” coolant pump 5₁ below in order to distinguish it better. Furthermore, the first coolant circuit 2.1 can be coupled thermally to the electrochemical cell 1. For example, the first coolant circuit 2.1 can also comprise a heat exchanger (not illustrated) for heat exchange with the electrochemical cell 1. Preferably, the first coolant circuit 2.1 here is designed to transfer heat between the electrochemical cell 1 and the first heat exchanger W₁ by means of a first coolant.

Furthermore, the vehicle 10 comprises a second coolant circuit 2.2 fluidically separated from the first coolant circuit 2.1, wherein the first coolant circuit 2.1 and the second coolant circuit 2.2 are thermally coupled to each other via an exchange heat exchanger W_{A}. This means, in other words, that heat can be exchanged between the first coolant circuit 2.1 and the second coolant circuit 2.2 via the exchange heat exchanger W_{A}. Preferably, with respect to a coolant flow within the first coolant circuit 2.1, the exchange heat exchanger W_{A} is arranged upstream of the first heat exchanger W₁ and downstream of the electrochemical cell 1. The second coolant circuit 2.2 also has a second heat exchanger W₂ for heat exchange with the vehicle surroundings, wherein the second coolant circuit 2.2 in turn can also comprise a coolant pump 5₂, which is to be designated as a “second” coolant pump 5₂ below. Preferably, the second coolant circuit 2.2 is designed to transfer heat between the exchange heat exchanger W_{A} and the second heat exchanger W₂ by means of a second coolant.

In order advantageously to ensure the highest possible temperature difference between the vehicle surroundings and the respective heat exchangers W₁ and W₂ and therefore to achieve the greatest possible cooling output, the first heat exchanger W₁—seen in the forward direction of travel V—is arranged in front of the second heat exchanger W₂. For example, the rear side 9 of the first heat exchanger W₁—seen in the forward direction of travel—can be arranged in front of the front side 11 of the second heat exchanger W₂. Additionally or alternatively, for example, the center of gravity of the first heat exchanger W₁ (seen in the forward direction of travel) can also be located in front of the center of gravity of the second heat exchanger W₂. In the present embodiment, for this purpose the first heat exchanger W₁ is arranged by way of example in the area of a radiator grille 4 closing off the vehicle front, and the second heat exchanger W₂ is arranged on an outer rear wall of the driver's cab 3 (i.e. “on the tower”). In order in addition advantageously to avoid ambient air warmed by the first heat exchanger W₁ flowing around the second heat exchanger W₂, the second heat exchanger W₂ is also—once more merely by way of example—arranged higher than the first heat exchanger W₁ in the vehicle vertical direction H. Overall, therefore, modular cooling of the electrochemical cell 1 is advantageously provided, the possible operating modes of which will be discussed in more detail in connection with FIG. 2.

FIG. 2 shows a schematic illustration of a vehicle 10 according to a second embodiment of the invention, in order to illustrate once more some details relating to the operation of the cooling of the electrochemical cell 1 more accurately. As distinct from the embodiment illustrated in FIG. 1, the vehicle 10 of the second embodiment also comprises control equipment 8 for activating the first and second coolant pump 5₁, 5₂. The control equipment 8 is designed to operate only the first coolant circuit 2.1 for cooling the electrochemical cell 1 in a first operating mode M₁, and to operate the first coolant circuit 2.1 and the second coolant circuit 2.2 in a second operating mode M₂. In the case of the second operating mode M₂, in which both coolant circuits 2.1 and 2.2 are operated, via the coupling of the two coolant circuits 2.1 and 2.2 via the exchange heat exchanger W_{A}—preferably arranged upstream of the first heat exchanger W₁ and downstream of the electrochemical cell 1 with respect to a coolant flow within the first coolant circuit 2.1—pre-cooling increasing the overall efficiency of the system can advantageously be implemented. Thus, the coolant of the first coolant circuit 2.1 emerging at the electrochemical cell 1, in particular in high-load or full-load operation, at high temperature, can partly be cooled firstly via flowing through the exchange heat exchanger W_{A} and the second coolant circuit 2.2 thermally coupled thereto, before it reaches the first heat exchanger W₁ connected downstream.

Preferably, the first coolant circuit 2.1 is designed for cooling the electrochemical cell 1 under average load, while the combination or coupling of the first and second coolant circuits 2.1, 2.2 can be designed for cooling the electrochemical cell 1 under high or full load. Thus, overall expedient and energy-efficient cooling of the electrochemical cell 1 can advantageously be achieved, in which, “in regular operation”, adequate cooling with the first coolant circuit 2.1—averagely dimensioned with respect to cooling output and energy consumption—can be achieved but short-term output peaks can be intercepted by connecting up the second coolant circuit 2.2 or by the operation of both coolant circuits 2.1 and 2.2. Additionally or alternatively, the control equipment 8 can also be designed to independently determine an operating mode of the first and/or second coolant circuit 2.1, 2.2 that is optimized with regard to a predefined target function (e.g. a target function relating to energy minimization). For example, whether, on the basis of the predefined target function and the current conditions (such as the necessary cooling output, ambient temperatures at the location of the heat exchangers W₁ and W₂, etc.) it is currently advantageous to operate the coolant circuits 2.1, 2.2 in the first operating mode M₁ or second operating mode M₂.

FIG. 3 shows a schematic illustration of a vehicle 10 according to a third embodiment of the invention. As distinct from the embodiment illustrated in FIG. 2, the second coolant circuit 2.2 in the present case is designed as a refrigerant circuit. This means that instead of a coolant, which is merely capable of transporting the entropy along the temperature gradient to a point of lower temperature in a cooling cycle, in the present refrigerant circuit there circulates a refrigerant which, in a refrigerating cycle, can also transfer heat counter to a temperature gradient. The refrigerant can be, for example, CO₂ or R1234yf. Instead of a coolant pump 5₂, the refrigerant circuit can correspondingly have a refrigerant pump or a compressor 6. In addition, the refrigerant circuit can comprise a throttling device 7 (e.g. in the form of an expansion valve and/or a capillary tube). The latter is preferably used to expand the refrigerant, i.e. to dissipate its pressure, as a result of which the boiling point of the refrigerant is lowered. In the exchange heat exchanger W_{A} connected downstream, the refrigerant can then evaporate, taking up heat. In a corresponding way, the exchange heat exchanger W_{A} in this embodiment functions as an evaporator in the refrigerant circuit. The refrigerant can then flow to the compressor 6, in which the gaseous refrigerant is compressed, so that the process can begin again. Here, it goes without saying that the techniques and features described with reference to FIG. 3 can be combined with the techniques and features which are described with reference to FIGS. 1 and 2, individually or in any combination.

Although the invention has been described with reference to specific exemplary embodiments, it is obvious to those skilled in the art that various changes can be implemented and equivalents can be used as a substitute without departing from the scope of the invention. Consequently, the invention is not intended to be restricted to the exemplary embodiments disclosed but to comprise all the exemplary embodiments which fall within the scope of the appended patent claims. In particular, the invention also claims protection for the subject matter and the features of the sub-claims, independently of the claims to which reference is made.

### LIST OF DESIGNATIONS

1 Electrochemical cell
2.1 First coolant circuit
2.2 Second coolant circuit
3 Driver's cab
4 Radiator grille
5₁ First coolant pump
5₂ Second coolant pump
6 Compressor
7 Throttling device
8 Control equipment
9 Rear side of the first heat exchanger
10 Vehicle
11 Front side of the second heat exchanger
H Vehicle vertical direction
M₁ First operating mode
M₂ Second operating mode
V Forward direction of travel
W₁ First heat exchanger
W₂ Second heat exchanger
W_{A} Exchange heat exchanger

1-15. (canceled)

16. A vehicle comprising:
an electrochemical cell;
a first coolant circuit for cooling the electrochemical cell, having a first heat exchanger for heat exchange with the vehicle surroundings;
a second coolant circuit, fluidically separated from the first coolant circuit, having a second heat exchanger for heat exchange with the vehicle surroundings;
wherein the first coolant circuit and the second coolant circuit are thermally coupled to each other via an exchange heat exchanger;
wherein the first heat exchanger, seen in the forward direction of travel of the vehicle, is arranged in front of the second heat exchanger.

17. The vehicle of claim 16, wherein the vehicle is a utility vehicle.

18. The vehicle of claim 16, wherein the vehicle comprises a driver's cab and the second heat exchanger, seen in the forward direction of travel, is arranged behind the driver's cab and/or is arranged on an outer rear wall of the driver's cab.

19. The vehicle of claim 16, wherein the first heat exchanger is arranged next to a vehicle front of the vehicle and/or next to a radiator grille of the vehicle.

20. The vehicle of claim 16, wherein:
the first heat exchanger, seen in the forward direction of travel, is arranged in front of the electrochemical cell; and/or
the second heat exchanger, as seen in the forward direction of travel, is arranged behind the electrochemical cell; and/or
the electrochemical cell, seen in the forward direction of travel, is arranged between the first heat exchanger and the second heat exchanger.

21. The vehicle of claim 16, wherein the second heat exchanger is arranged higher with respect to the vehicle vertical direction than the first heat exchanger.

23. The vehicle of claim 16, wherein with respect to a coolant flow within the first coolant circuit, the exchange heat exchanger is arranged upstream of the first heat exchanger and downstream of the electrochemical cell.

24. The vehicle of claim 16, wherein:
a) the second coolant circuit is used for pre-cooling the first coolant circuit; and/or
b) no further components to be cooled and/or to be heated are incorporated in the second coolant circuit; and/or
c) the second coolant circuit is thermally coupled to the electrochemical cell via the exchange heat exchanger and the first coolant circuit.

25. The vehicle of claim 24, wherein:
the second coolant circuit is used exclusively for pre-cooling the first coolant circuit; and/or
the second coolant circuit is thermally coupled to the electrochemical cell exclusively via the exchange heat exchanger and the first coolant circuit.

26. The vehicle of claim 16, wherein the first coolant circuit is designed to dissipate heat from the electrochemical cell to the second coolant circuit by means of the exchange heat exchanger in a first phase of the cooling and to dissipate it to the vehicle surroundings by means of the first heat exchanger in a second phase of the cooling.

27. The vehicle of claim 16, wherein
a) the first heat exchanger is an air/coolant heat exchanger; and/or
b) the second heat exchanger is an air/coolant heat exchanger; and/or
c) the exchange heat exchanger is a coolant/coolant heat exchanger.

28. The vehicle of claim 16, wherein control equipment, which is designed to operate the first coolant circuit and/or the second coolant circuit.

29. The vehicle of claim 16, wherein the control equipment is designed to operate the first coolant circuit independently of the second coolant circuit.

30. The vehicle of claim 28, wherein the control equipment is designed to operate only the first coolant circuit for cooling the electrochemical cell in a first operating mode; and to operate the first coolant circuit and the second coolant circuit in a second operating mode.

31. The vehicle of claim 30, wherein:
the first operating mode is a low-load operation; and/or
the second operating mode is a full-load operation.

32. The vehicle of claim 28, wherein the control equipment is designed to determine an operating mode of the first and/or second coolant circuit that is optimized with regard to a predefined target function relating to energy minimization, and to operate the first and/or second coolant circuit in accordance with the determined optimized operating mode.

33. The vehicle of claim 16, wherein the second coolant circuit is a refrigerant circuit with a compressor and a throttling device.

34. A method for operating a vehicle as claimed in claim 16, comprising the steps:
determining an operating mode of the first and/or second coolant circuit that is optimized with respect to a predefined target function; and
operating the first and/or second coolant circuit in accordance with the determined optimized operating mode.

35. The method of claim 34, wherein the predefined target function relates to energy minimization.
